(19) United States
(12) Patent Application Publication
(10) Pub. No.: US 2010/0132396 A1
(43) Pub. Date: Jun. 3, 2010

(54) ICE DISPENSER

(76) Inventors: Sonoo Kato, Aichi (JP); Chiyoshi Toya, Aichi (JP)

Correspondence Address: Quinn Emanuel Urquhart & Sullivan, LLP, 865 S. FIGUEROA STREET, 10TH FLOOR, LOS ANGELES, CA, 90017, US

(21) Appl. No.: 12/452,548

(22) PCT Filed: Apr. 17, 2008
(86) PCT No.: PCT/JP2008/057297

§ 371 Date: Jan. 8, 2010

(30) Foreign Application Priority Data
Jul. 24, 2007 (JP) 2007-192496

(51) Int. Cl. F25C 5/18; B67D 7/76

(52) U.S. Cl. 62/344; 222/189.05

(57) ABSTRACT

An ice dispenser includes a discharge mechanism (30) provided between an ice storage room (10) having an ice discharge opening (14) provided at a bottom portion, and a chute (20) for guiding ice received at a reception/delivery opening (22) arranged away from a position directly under the discharge opening (14). The discharge mechanism (30) includes a fixed member (32) extending from under the discharge opening (14) to an edge portion of the reception/delivery opening (22), and a moving member (36) which is reciprocated along the fixed member (32) by a drive section (40), and has a plurality of vertically penetrating holes (38) formed spaced apart in a moving direction. The discharge mechanism (30) is configured so that a control section controls a drive section (40) to change an amount of movement of the moving member (36) from the discharge opening (14) side to the reception/delivery opening (22) side, thereby adjusting a total number of the holes (38) made to sequentially face the reception/delivery opening (22) according to an amount of supply of the ice input from an input section.

### TECHNICAL FIELD

The present invention relates to an ice dispenser from which ice stored in an ice storage room can be adequately taken out.

### BACKGROUND ART

Ice dispensers configured to be able to store ice produced by an ice making machine into an ice storage room and allow the ice to be taken outside as needed by a discharge mechanism are used for the business purpose in restaurants or the like which use a large amount of ice (see, for example, Patent Document 1). The ice dispenser illustrated in Patent Document 1 has an ice storage room provided with an agitator having an arm extending radially of the rotary shaft extending in an upward/downward direction, so that rotating the agitator causes the arm to push and discharge the ice from a discharge opening provided at the side portion of the ice storage room.

An ice dispenser equipped with another discharge mechanism is proposed as illustrated in Patent Document 2. The discharge mechanism of the ice dispenser in Patent Document 2 has a measuring instrument movably disposed between an ice storage room and a fixed plate disposed thereunder, with a plurality of vertically penetrating measuring sections formed in the measuring instrument. A plurality of discharge openings are formed in the bottom of the ice storage room, and a plurality of openings are formed in the fixed plate at positions spaced apart forward from directly under the discharge openings, and at the same pitches as the measuring sections of the measuring instrument. That is, the measuring sections of the measuring instrument and the openings of the fixed plate are provided in a 1-to-1 corresponding relation. The measuring instrument reciprocates between a measuring position at which each measuring section comes under the respective discharge opening, and a discharge position at which the measuring section communicates with the opening of the fixed plate to discharge ice from the measuring section.

In the ice dispenser, the measuring section whose bottom is blocked with the fixed plate receives ice by the capacity of this measuring section at the measuring position from the ice storage room, and the measuring instrument is moved along the fixed plate by a prescribed distance to the discharge position with the ice held by the fixed plate and the measuring section. As the measuring instrument is moved to the discharge position, each measuring section faces the respective opening, and ice by the capacity of the measuring section is supplied to a cup via the opening. In this manner, the ice dispenser in Patent Document 2 can supply a given amount of ice measured by each measuring section to each of a plurality of cups.

### Patent Document 1: Japanese Patent Application Laid-Open No. 2004-347293

Patent Document 2: Japanese Utility Model Application Laid-Open No. Hei 6-46325

### DISCLOSURE OF THE INVENTION

### Problems to be Solved by the Invention

Ice dispensers are demanded not only to supply a given amount of ice but also take out supplied ice measured according to the size of a container and the usage of the ice. The ice dispenser in Patent Document 1 does not measure ice to be discharged, but requires that a user should adjust the time of rotating the agitator to take out an intended amount of ice, which is troublesome. In addition, taking out a large amount of ice inconveniently takes time.

While the ice dispenser in Patent Document 2 can allow ice measured by an integer multiple of the capacity of the measuring section to be taken out by reciprocating the measuring instrument plural times, taking out a large amount of ice takes time. Further, although the capacity of the measuring section can be changed by replacing the measuring instrument, or attaching or detaching a plate to or from the measuring instrument, it takes considerable trouble, and it is difficult to meet various demands of users because of the narrow range of adjustment of the supply amount.

Accordingly, the present invention has been proposed to adequately overcome the inherent problems of the ice dispensers according to the related arts, and it is an object of the invention to provide an ice dispenser capable of easily adjusting the amount of supply of the ice.

### Means for Solving the Problems

To overcome the problems and achieve the expected object, an ice dispenser according to the invention of claim 1 of the present application includes:

an ice storage room having a discharge opening for ice provided at a bottom portion;

a chute, provided under the ice storage room, for guiding the ice received at a reception/delivery opening arranged away from a position directly under the discharge opening;

a fixed member extending from under the discharge opening to at least an edge portion of the reception/delivery opening;

a moving member provided between the discharge opening and the fixed member in such a way as to be movable along the fixed member, and having a plurality of vertically penetrating holes formed spaced apart in a moving direction;

a drive section that moves the moving member to cause the individual holes to come under the discharge opening and cause each hole to come over the reception/delivery opening;

an input section that sets an amount of supply of the ice; and

a control section that controls the drive section according to the amount of supply of the ice input from the input section to change an amount of movement of the moving member from the discharge opening side to the reception/delivery opening side, thereby adjusting a total number of the holes sequentially facing the reception/delivery opening.

According to the invention of claim 1 of the present application, a desired amount of ice measured can be supplied outside from the ice storage room within the range of the capacity provided by adding the holes with a simple structure of merely adjusting the total number of the holes which are made to face the reception/delivery opening by changing the amount of movement of the moving member. In addition, the amount of supply of ice can be adjusted by moving the moving member from the discharge opening side to the reception/delivery opening side once, not plural times, so that the time needed for supplying ice can be made shorter even when the amount of supply of ice becomes larger.

### EFFECT OF THE INVENTION

The ice dispenser according to the invention can supply a desired amount of ice measured within the range of the capacity of a plurality of holes formed in the moving member, and can supply ice in a short period of time even when the amount of supply of ice becomes larger.

### BRIEF DESCRIPTION OF DRAWINGS

FIG. 1 is a side cross-sectional view showing the essential portions of an ice dispenser according to a preferable embodiment of the invention.

FIG. 2 is a plan view showing the essential portions of the ice dispenser according to the embodiment.

FIG. 3 is a cross-sectional view along line X-X in FIG. 1.

FIG. 4 is a control block diagram of the ice dispenser according to the embodiment.

FIG. 5 is a schematic perspective view showing a moving member and a fixed member according to the embodiment.

FIG. 6 is a side cross-sectional view illustrating the operation of the discharge mechanism of the ice dispenser according to the embodiment; (a) shows a state where the moving member stands by at a measuring position, (b) shows a state where the moving member is at a first discharge position, (c) shows a state where the moving member is at a second discharge position, (d) shows a state where the moving member is at a third discharge position, (e) shows a state where the moving member is at a fourth discharge position, (f) shows a state where the moving member is at a fifth discharge position, and (g) shows a state where the moving member is moving from the reception/delivery opening side to the measuring position side.

FIG. 7 is a schematic perspective view showing a moving member according to a modification example.

### BEST MODE FOR CARRYING OUT THE INVENTION

An ice dispenser according to preferred embodiment the present invention will now be described by way of a preferred embodiment with reference to the accompanying drawings.

### Embodiment

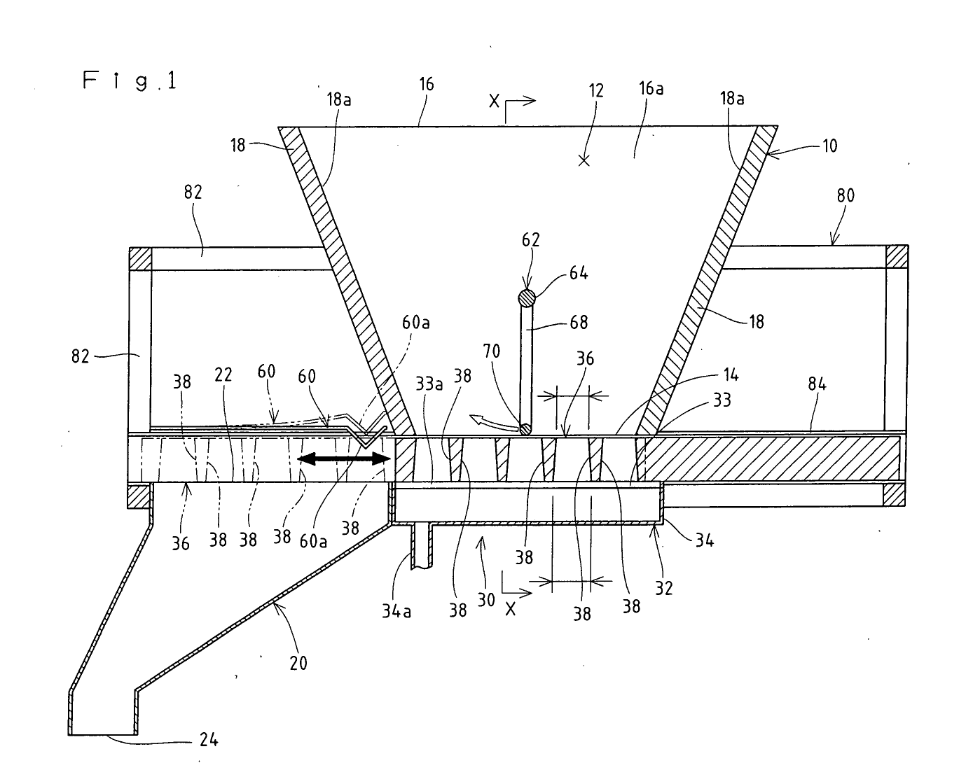

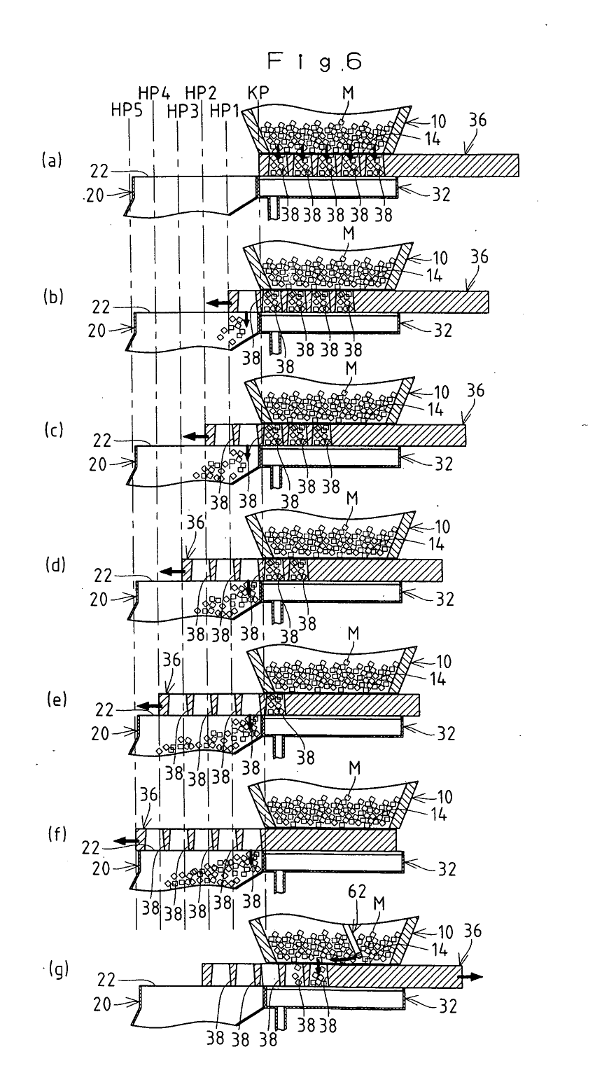

As shown in FIGS. 1 to 3, an ice dispenser according to the embodiment includes an ice storage room 10 which stores ice M (see FIG. 6) produced by an unillustrated ice making machine, a chute 20 provided under the ice storage room 10 to guide the ice M outside, and a discharge mechanism 30 which discharges a desired amount of ice M to the chute 20 from the ice storage room 10. The ice dispenser has, inside, a frame body 80 which has a plate member 82 formed into a rectangular cubic shape, and at which the ice storage room 10, the chute 20 and the discharge mechanism 30 are provided.

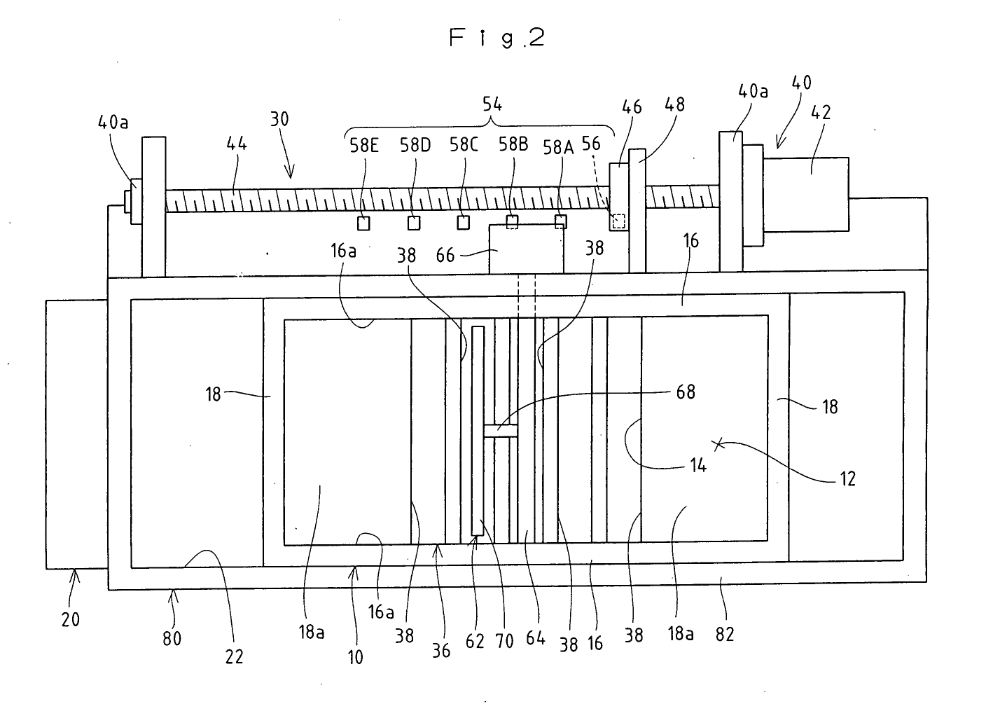

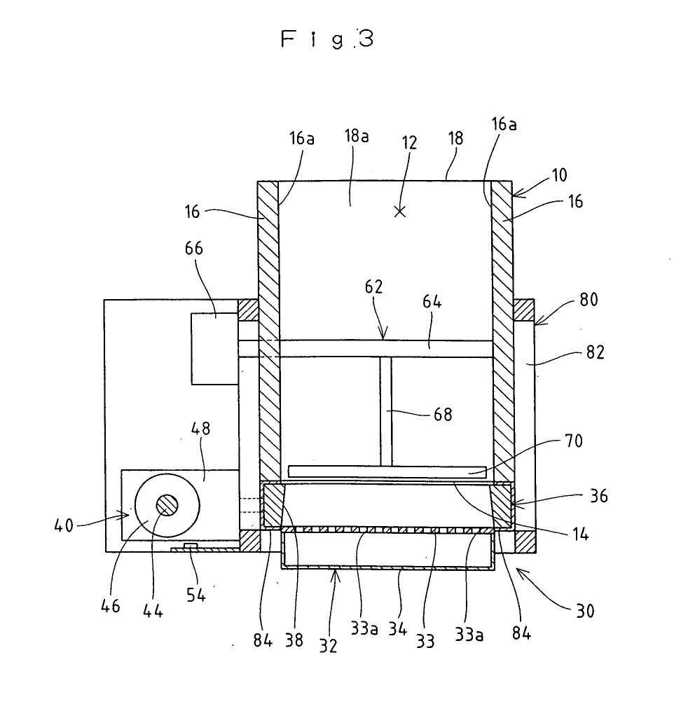

The ice storage room 10 is an approximately rectangular box (see FIG. 2) as viewed planarly, has, inside, an ice storage chamber 12 and a discharge opening 14 provided at the bottom portion to communicate with the ice storage chamber 12, and is disposed with the lower portion facing the inner region of the frame body 80. The ice storage room 10 has the lengthwise sides arranged along the moving direction of a moving member 36 to be described later. The ice storage room 10 has one set (hereinafter called first side wall portions) of opposite sets of side wall portions 16, 18 provided upright perpendicularly (see FIG. 3), and the other set (hereinafter called second side wall portions) of the opposite sets of side wall portions 16, 18 provided inclined so as to come closer to each other in an upward-to-downward direction (see FIG. 1). First inner wall surfaces (inner wall surfaces) 16a of the first side wall portions 16 which face the ice storage chamber 12 extends perpendicularly, second inner wall surfaces (inner wall surfaces) 18a of the second side wall portions 18 which face the ice storage chamber 12 are inclined downward toward the discharge opening 14 at the bottoms, and the inclined lower ends of the second inner wall surfaces 18a form the opening edge of the discharge opening 14. The lower ends of the first inner wall surfaces 16a constitute the opening edge of the discharge opening 14. The shapes of the inner wall surface 16a, 18a in the ice storage room 10 are determined based on the moving direction of the moving member 36 of the discharge mechanism 30 which will be described later, and the inner wall surfaces 16a, 16a of the side wall portions 16, 16 along the moving direction of the moving member 36 are formed perpendicularly while the inner wall surfaces 18a, 18a of the side wall portions 18, 18 which cross the moving direction of the moving member 36 are obliquely formed.

The chute 20 is a cylindrical member, and has a reception/delivery opening 22 open upward provided at an upper end portion arranged inside the body of the ice dispenser, the upper end portion being arranged at the bottom portion of the frame body 80 in the embodiment (see FIG. 1). The chute 20 has an take-out opening 24 facing outside the body of the ice dispenser, so that ice M received at the reception/delivery opening 22 is guided and discharged from the take-out opening 24. The reception/delivery opening 22 of the chute 20 is arranged away from a position directly under the discharge opening 14.

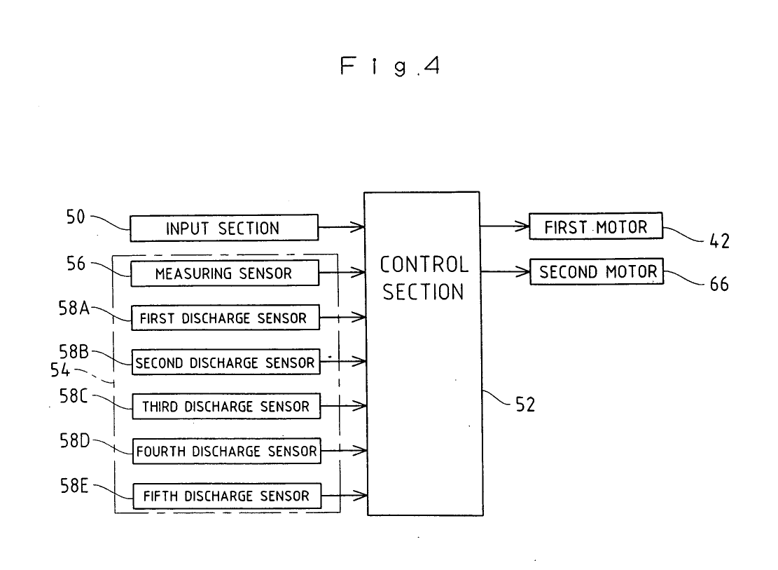

The discharge mechanism 30 includes a fixed member 32 provided between the discharge opening 14 of the ice storage room 10 and the reception/delivery opening 22 of the chute 20, the moving member 36 provided movably between the ice storage room 10 and the fixed member 32 and has a plurality of holes 38 for receiving ice M, and a drive section 40 that moves the moving member 36. The discharge mechanism 30 also includes an input section 50 which sets the amount of supply of ice M, and a control section 52 that controls the drive section 40 according to the amount of supply of the ice M set at the input section 50 (see FIG. 4). The discharge mechanism 30 receives ice M via the discharge opening 14 from the ice storage room 10 at the individual holes 38 whose bottoms are blocked with the top surface of the fixed member 32, and drives the drive section 40 under control of the control section 52 to move the moving member 36 toward the reception/delivery opening 22 from the discharge opening 14 side and push out the ice M into the reception/delivery opening 22 from the discharge opening 14 at the individual holes 38. The discharge mechanism 30 is configured in such a way that the moving member 36 moves toward the reception/delivery opening 22 from the discharge opening 14 side to an arbitrary position (discharge position HP to be described later) (see FIG. 6), and the holes 38 whose quantity corresponds to the amount of supply of ice M set at the input section 50 face the reception/delivery opening 22. Further, the discharge mechanism 30 according to the embodiment is configured to include position detection means 54 which detects the position of the moving member 36, so that the control section 52 can change over the drive direction of the drive section 40 or stop the drive section 40 based on the position of the moving member 36 detected by the position detection means 54.

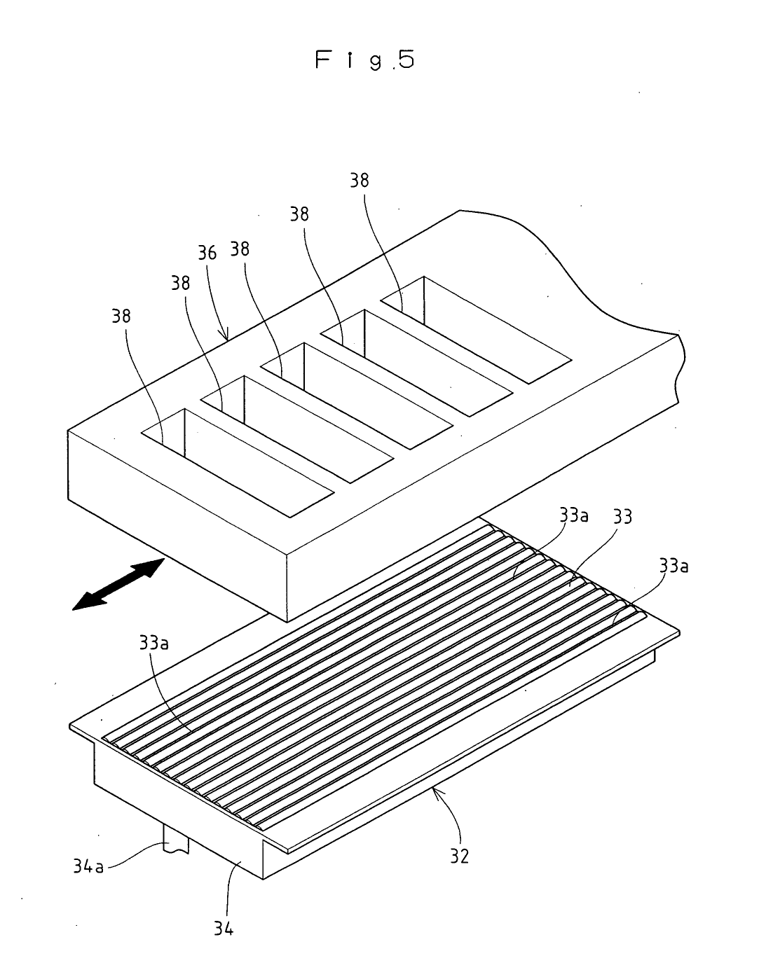

The fixed member 32 constitutes the bottoms of the holes 38 provided in the moving member 36 disposed above, is disposed horizontally at the bottom portion of the frame body 80 and extends from directly under the discharge opening 14 of the ice storage room 10 to the opening edge (edge portion) of the reception/delivery opening 22 of the chute 20 on the discharge opening 14 side. As shown in FIG. 5, the fixed member 32 has vertically penetrating through holes 33a, and includes a separator 33 which constitutes the top surface of the fixed member 32 and a discharge pan 34 provided under the separator 33 to receive ice-melted water falling down via the through holes 33a of the separator 33. The separator 33 is a drainboard-like member having the plurality of through holes 33a formed along the moving direction of the moving member 36 and arranged in a direction (rightward/leftward direction) crossing the moving direction of the moving member 36, and is configured to inhibit passage of ice M via the through holes 33a and allow down-flow of the ice-melted water by setting the width of the through holes 33a smaller than the ice M. It is to be noted that a discharge pipe 34a communicating with the outside is connected to the bottom portion of the discharge pan 34, so that the ice-melted water collected in the discharge pan 34 can be discharged outside through the discharge pipe 34a.

The moving member 36 is an approximately rectangular member having the upper and lower dimensions set substantially equal to the interval between the lower end edge of the ice storage room 10 and the top surface of the fixed member 32, and having lengthwise sides extending in the moving direction (see FIG. 5), and has side edges held by frame members 84, 84 arranged opposite to each other at both side portions of the frame body 80 and having an approximately C-shaped cross section, and can be reciprocated horizontally along the top surface of the fixed member 32. The moving direction of the moving member 36 is along a line which is the projection onto a horizontal plane of the line connecting the discharge opening 14 and the reception/delivery opening 22 provided away a position directly under the discharge opening 14; the direction from the discharge opening 14 side toward the reception/delivery opening 22 is “forward”, and the direction from the reception/delivery opening 22 side toward the discharge opening 14 is “rearward”. As the moving member 36 is reciprocated in the forward/rearward direction by the drive section 40, it is displaced between a measuring position KP at which the holes 38 are made to face the discharge opening 14 of the ice storage room 10 and a plurality of discharge positions HP1 to HP5 according to the holes 38 which are made to face the reception/delivery opening 22 of the chute 20 (see FIG. 6).

The moving member 36 has the plurality of vertically penetrating holes 38 spaced apart from each other in the moving direction of the moving member 36; the holes 38 of the same rectangular shape as viewed planarly are arranged in series at five locations at given intervals in the embodiment. Each hole 38 is formed so as to expand in the up-to-down direction, so that the lower opening is larger than the upper opening (see FIG. 1). The plurality of holes 38 in the moving member 36 are formed in a biased manner in a forward area in the moving direction; in the embodiment, the distance from the forward opening edge of the frontmost hole 38 in the plurality of holes 38 in the moving direction to the rearward opening edge of the rearmost hole 38 in the moving direction is set equal to the front-rear dimension of the discharge opening 14. Further, the distance from the rearward opening edge of the frontmost hole 38 in the plurality of holes 38 in the moving member 36 in the moving direction to the rear end is set greater than the front-rear dimension of the discharge opening 14. That is, the moving member 36 is set in such a way that at the measuring position KP, every hole 38 is positioned under the discharge opening 14 to communicate therewith, and when the moving member 36 moves (reciprocates) forward, the discharge opening 14 is blocked at the top surface of the moving member 36.

The discharge mechanism 30 is set in such a way that ice M whose amount corresponds to the capacity of the hole 38 is received in the hole 38 from the discharge opening 14 at the measuring position KP (see FIG. 6(a)), and is delivered to the reception/delivery opening 22 according to the movement of the moving member 36, and the number of the holes 38 which are made to face the reception/delivery opening 22 is changed by changing the amount of movement of the moving member 36 (see FIGS. 6(b) to 6(f)), thereby adjusting the amount of supply of the ice M within the range of the capacity provided by adding the capacities of a plurality of holes 38. That is, because the holes 38 at five locations are set to the same capacity in the discharge mechanism 30 of the embodiment, ice M can be supplied in a supply amount measured for each integer multiple of the capacity of a single hole 38 within the range from the capacity of one hole 38 to the capacity obtained by adding the capacities of the five holes 38.

The drive section 40 is provided on one side portion of the frame body 80, and includes a first motor 42, a screw shaft 44 connected thereto and extending along the moving direction of the moving member 36, and a change nut 46 screwed onto the screw shaft 44 and connected to the moving member 36 via a link piece 48 (see FIG. 2). The screw shaft 44 is rotatably held by a pair of bearings 40a, 40a provided at the frame body 80 at the forward and rear portions in the moving direction apart from each other. When the screw shaft 44 of the drive section 40 rotates in one direction, the change nut 46 is moved forward, whereas when the screw shaft 44 rotates in the other direction by the reverse rotation of the first motor 42, the change nut 46 is moved rearward. That is, in the discharge mechanism 30, the moving member 36 is reciprocated forward and rearward according to the movement of the change nut 46. As the drive section 40 changes the rotational direction of the first motor 42 under control of the control section 52, the moving member 36 is moved forward to the discharge position HP1-HP5 corresponding to each hole 38 made to face the reception/delivery opening 22, and is then moved (moved rearward) toward the discharge opening from the reception/delivery opening side. Further, the drive section is configured in such a way that the first motor 42 is stopped under control of the control section 52 to stop the forward area of the moving member 36 where the holes 38 are formed at the measuring position KP arranged directly under the discharge opening 14 of the ice storage room 10.

The position detection means 54 includes a plurality of (six in the embodiment) sensors 56, 58 positioned directly under the moving locus of the change nut 46 and provided apart from one another in the moving direction of the moving member 36 (see FIG. 2 or FIG. 3). A proximity switch, such as a reflection optical sensor or Hall IC, is used as each sensor 56, 58, and when the change nut 46 comes directly above the layout position of the sensor 56, 58, the corresponding sensor 56, 58 detects the change nut 46. Because the discharge mechanism 30 in the embodiment is configured in such a way that the moving member 36 is moved forward or rearward according to the forward/rearward movement of the change nut 46, the position of the moving member 36 can be detected indirectly by detecting the position of the change nut 46.

The position detection means 54 is separated into one measuring sensor 56 that detects the measuring position KP of the moving member 36, and a plurality of (five) discharge sensors 58 that detect respective discharge positions HP1 to HP5 which fully communicate with the reception/delivery opening 22 when the bottoms of the holes 38 blocked with the fixed member 32 are set open. In case of particularly distinguishing the discharge sensors 58, the sensor adjacent to the measuring sensor 56 in the forward direction is called “first discharge sensor 58A”, and the other sensors are respectively called “second discharge sensor 58B”, “third discharge sensor 58C”, “fourth discharge sensor 58D” and “fifth discharge sensor 58E” in order in the forward direction. The discharge mechanism 30 is configured in such a way that when the first discharge sensor 58A detects the change nut 46 at the time the moving member 36 moves forward from the measuring position KP, the frontmost hole 38 of the moving member 36 communicates with the reception/delivery opening 22. In the discharge mechanism 30, when the n-th discharge sensor 58 located frontward of the measuring sensor 56 detects the change nut 46, the n-th hole 38 from the forward side of the moving member 36 communicates with the reception/delivery opening 22, and detection of the change nut 46 by each discharge sensor 58 and communication of each discharge sensor 58 with the reception/delivery opening 22 are set in a 1-to-1 corresponding relation.

The input section 50 in the embodiment is operational means, such as a button or lever, provided at an outer portion of the ice dispenser, and as a user operates the input section 50, the amount of supply of ice M in a predetermined range can be set in the control section 52. The control section 52 controls the driving of the first motor 42, and is set in such a way that at the time of moving the moving member 36 forward from the measuring position KP, particularly, the holes 38 the total number of which corresponds to the amount of supply of ice M set at the input section 50 are moved to a corresponding one of the discharge positions HP1 to HP5 at which those holes 38 are made to face the reception/delivery opening 22. Here, the control section 52 in the embodiment changes over the drive direction of the first motor 42 or stop the first motor 42 based on the position of the moving member 36 detected by the position detection means 54.

Specifically, when the amount of supply of ice M which corresponds to the total number of the holes 38 up to the n-th hole from the front one is set, the discharge mechanism 30 causes the control section 52 to drive the first motor 42 forward by the control section 52 to move the moving member 36 forward until the position is detected by the discharge sensor HP corresponding to the n-th hole 38 in the moving member 36 from the front one. Then, the discharge mechanism 30 causes the control section 52 to drive the first motor 42 reversely to move the moving member 36 rearward based on the position detected by the n-th discharge sensor 58, and causes the control section 52 to stop the first motor 42 based on the position detected by the measuring sensor 56, and causes the moving member 36 to stand by at the measuring position KP.

The discharge mechanism 30 has a pressing piece 60 which assists in separating ice M from the hole 38 facing the reception/delivery opening 22 of the chute 20 (see FIG. 1). The pressing piece 60 is not shown in FIGS. 2 and 6. The pressing piece 60 is an elastically deformable plate-like member having one end (front end in the embodiment) fixed to the frame body 80 and the body of the ice dispenser and supported in a horizontally extending cantilever state, and the other end (rear end) side bendable in the upward/downward direction. The pressing piece 60 is provided over the top surface of the moving member 36 extending over the reception/delivery opening 22 at each discharge position HP, and has at least the other end arranged to extend over the reception/delivery opening 22. A single projection 60a projecting downward is formed at the other end of the pressing piece 60 at a position where it is aligned with the corresponding hole 38 facing the reception/delivery opening 22 at each discharge position HP of the moving member 36, the lower end of the projection 60a being set to be positioned under the top surface of the moving member 36. The projection 60a is inclined rearward in the up-to-down direction of the front-side face of the moving member 36 in the moving direction of the moving member 36, is inclined forward in the up-to-down direction of the rear-side face of the moving member 36, and is formed bent in an isosceles triangular shape as viewed from the side in the embodiment. That is, the pressing piece 60 is formed in such a way that the movement of the moving member 36 is allowed as the projection 60a is placed in the hole 38 facing above the reception/delivery opening 22 to push out the remaining ice M downward into the hole 38, and the projection 60a is pushed to the top surface of the moving member 36 to be deformed elastically at the time of moving the moving member 36 forward/rearward.

The ice storage chamber 12 of the ice storage room 10 is provided with an agitator 62 which agitates ice M stored in the ice storage chamber 12 (see FIG. 1). The agitator 62 includes a rotary shaft 64 extending in the rightward/leftward direction of the ice storage chamber 12, a second motor 66 which rotates the rotary shaft 64, a first agitating section 68 extending radially of the rotary shaft 64, and a second agitating section 70 provided at the distal end of the first agitating section 68 and extending in the rightward/leftward direction, and the first agitating section 68 and the second agitating section 70 which agitate ice M form a T shape (see FIG. 2). The second motor 66 is provided outside the ice storage room 10. The position of the rotary shaft 64 and the length or the like of the first agitating section 68 of the agitator 62 are set in such a way that the second agitating section 70 rotates brushing the top surface of the moving member 36 facing the interior of the ice storage chamber 12 from the discharge opening 14 of the ice storage room 10. The right to left dimension of the second agitating section 70 are set equal to or greater than the right to left dimension of the hole 38. At the time the second agitating section 70 brushes the top surface of the moving member 36 at the lower portion of the rotational locus of the second agitating section 70, the agitator 62 rotates in the forward direction of the moving direction of the moving member 36. The agitator 62 continuously or intermittently operates in a standby state where ice M is not taken out, and operates at least in the process of the rearward movement of the moving member 36 to the measuring position KP from the discharge position HP at the time of the ice take-out operation of the discharge mechanism 30.

### Operation of Embodiment

Next, the operation of the ice dispenser according to the embodiment will be described. In the standby state of the ice dispenser where the discharge mechanism 30 does not perform the ice take-out operation, the moving member 36 stands by at the measuring position KP (see FIG. 6(a)), and the agitator 62 continuously or intermittently operates so that the first agitating section 68 and the second agitating section 70 agitate the ice M stored in the ice storage chamber 12, preventing icing, blocking or the like of the ice. At the measuring position KP, the plurality of holes 38 of the moving member 36 are all positioned under the discharge opening 14, and the upper openings of the individual holes 38 communicate with the discharge opening 14. Meanwhile, because the lower openings of the plurality of holes 38 of the moving member 36 are blocked with the top surface of the fixed member 32 extending downward, ice M which falls from the ice storage chamber 12 through the discharge opening 14 due to the dead weight are filled in the individual holes 38. The top surface of the fixed member 32 is constituted by the separator 33 having the through holes 33a, ice M is held by the separator 33, and ice-melted water produced in the ice storage chamber 12 and the holes 38 flows down into the discharge pan 34 via the through holes 33a, so that the ice M filled in the holes 38 and the ice-melted water can be separated from each other. That is, it is possible to prevent the ice-melted water from being discharged together with the ice M from the chute 20. In addition, it is possible to avoid dropping of the ice-melted water from the fixed member 32, which would adversely affect other devices.

As the discharge mechanism 30 of the ice dispenser is operated through the operation of the input section 50 by the user, the set amount of supply of ice M is taken out. Specifically, in response to the operation of the input section 50, the first motor 42 of the drive section 40 in the ice dispenser is driven forward, and the change nut 46 is moved forward according to the rotation of the screw shaft 44, causing the moving member 36 to move forward toward the discharge position HP from the measuring position KP. At this time, the ice M filled in the holes 38 are held at the top surface of the fixed member 32 and is moved forward according to the movement of the moving member 36. Because the top to bottom dimension of the moving member 36 is set approximately equal to the interval between the lower end edge of the ice storage room 10 and the top surface of the fixed member 32, when the moving member 36 moves forward, the movement of the ice M above the top surface of the moving member 36 is restricted by the lower end edge of the ice storage room 10 so that the ice M does not move. In addition, the through holes 33a provided in the separator 33 which constitutes the top surface of the fixed member 32 is formed to extend in the moving direction of the moving member 36, and the opening edges of the through holes 33a extend in the moving direction of the moving member 36 and do not cross the moving direction, so that pressing of ice M into the holes 38 is not hindered. Further, the projection 60a of the pressing piece 60 is pressed by the top surface of the moving member 36 so that the body portion is elastically deformed and retarded upward, thus permitting the forward movement of the moving member 36. In this manner, the discharge mechanism 30 can feed the ice M toward the reception/delivery opening 22 while retaining a given amount of ice M corresponding to the capacity of each hole 38 therein, and each hole 38 function as a measuring part to measure the ice M received from the ice storage room 10.

As the discharge mechanism 30 moves the moving member 36 forward to the discharge position HP corresponding to the amount of supply of ice M set at the input section 50, the holes 38 whose total quantity corresponds to the amount of supply of ice M are made to face the reception/delivery opening 22. When the moving member 36 moves to the discharge position HP1, for example, the frontmost hole 38 comes out of the fixed member 32 to be positioned over the reception/delivery opening 22, releasing the lower opening of the hole 38, so that ice M held in the hole 38 and pushed out falls due to the dead weight (see FIG. 6(b)). When the moving member 36 comes to each discharge position HP, the projection 60a of the pressing piece 60 is placed into the hole 38 facing the reception/delivery opening 22 for the first time in correspondence to each discharge position HP, from above, to push out the ice M in the hole 38 downward, thus assisting the discharge of the ice M into the reception/delivery opening 22. Further, each hole 38 has a shape expanding from the upper opening toward the lower opening, making it easier for ice M to fall. Even when arching is caused by the surface tension of the ice M held in the hole 38 or compression originating from the pressure applied to the ice M at the time the ice M passes the lower end edge of the ice storage room 10, therefore, it is possible to prevent the ice M from remaining in the hole 32 for the shapes of the pressing piece 60 and the hole 38 due to the easier falling of ice M, and to stably deliver a measured amount of ice M to the chute 20. Then, the ice M received from the reception/delivery opening 22 is guided to the chute 20 to be supplied to a container (not shown) prepared at the take-out opening 24 of the chute 20. In this manner, as the discharge mechanism 30 moves forward the moving member 36 to the n-th discharge position HP, the holes 38 in the moving member 36 located up to the n-th hole from the front one face the reception/delivery opening 22, and ice M pushed out from each hole 38 is supplied via the chute 20.

Adjustment of the amount of supply of ice M according to the amount of movement of the moving member 36 will be described further. In case where the amount of supply of ice M corresponding to the sum of the capacities of two holes 38 is set at the input section 50 in the ice dispenser, for example, even when the moving member 36 is moved forward and the change nut 46 is detected by the first discharge sensor 58A corresponding to the first discharge position HP1, the control section 52 keeps driving the first motor 42 forward (FIG. 6(b)). When the moving member 36 comes to the first discharge position HP1, the frontmost hole 38 of the moving member 36 communicates with the reception/delivery opening 22, and ice M pushed out from the hole 38 is supplied outside via the chute 20. As the discharge mechanism 30 moves the moving member 36 further forward so that the second discharge sensor 58B corresponding to the second discharge position HP2 of the moving member 36 detects the change nut 46 (FIG. 6(c)), the control section 52 drives the first motor 42 reversely to move the moving member 36 rearward toward the discharge opening 14 from the reception/delivery opening 22 side (FIG. 6(g)). When the moving member 36 comes to the second discharge position HP, the second hole 38 of the moving member 36 from the front one communicates with the reception/delivery opening 22, and ice M pushed out from this hole 38 is supplied outside via the chute 20, so that a total of two holes 38, 38 face the reception/delivery opening 22 and ice M whose amount corresponding to the sum of the capacities of the two holes 38, 38 is take out.

The discharge mechanism 30 moves the moving member 36 rearward until the measuring sensor 56 detects the change nut 46, and the measuring sensor 56 detects the change nut 46, the control section 52 performs control to stop the first motor 42 to stop the moving member 36 at the measuring position KP. It is to be noted that the moving member 36 stands by at the measuring position KP until the next take-out operation of ice M is performed. When the moving member 36 moves rearward, an empty hole 38 is positioned under the discharge opening 14, and ice M falls in the hole 38 from the ice storage chamber 12 via the discharge opening 14 at which time the bottom of the hole 38 is blocked with the fixed member 32, causing the ice M to be filled in the hole 38. Because the agitator 62 provided in the ice storage chamber 12 of the ice storage room 10 is set in such a way that the rotational direction of the second agitating section 70 at the time of brushing the turning the top surface of the moving member 36 becomes opposite to the rearward direction which is the moving direction at the time the moving member 36 moves rearward, the ice M in the ice storage chamber 12 is guided into the hole 38 by the second agitating section 70. That is, the re-filling of ice M into the hole 38 is carried out positively by the agitator 62, not just by the dead-weight oriented free falling of ice M, so that even when the next take-out operation of ice M is carried out consecutively, a measured amount of ice M can be taken out.

According to the ice dispenser of the embodiment, as apparent from the above, as the amount of movement of the moving member 36 toward the reception/delivery opening 22 from the discharge opening 14 side is changed to adjust the number of the holes 38 which are made to face the reception/delivery opening 22, a measured amount of ice M can be supplied within the range of the sum of the capacities of a plurality of holes 38 with the simple structure of moving the moving member 36 using the single first motor 42. In addition, the set amount of supply of ice M can be supplied by moving the moving member 36 toward the reception/delivery opening 22 from the discharge opening 14 side merely once, and what is more, the amount of supply of ice M can be changed without moving the moving member 36 multiple times. That is, even when the amount of supply of ice M becomes larger, it is possible to restrain the time needed for taking out ice M from becoming longer, as compared with the structure that moves the moving member 36 multiple times.

The ice storage room 10 is configured in such a way that as the moving member 36 moves forward, ice M is pulled by the movement of the moving member 36 and can be guided to the discharge opening 14 along the inclination of the rear second inner wall surface 18a. In addition, the ice storage room 10 is configured in such a way that as the moving member 36 moves rearward, ice M is pulled by the movement of the moving member 36 and can be guided to the discharge opening 14 along the inclination of the forward second inner wall surface 18a. The inclined formation of the second inner wall surfaces 18a, 18a which cross the moving direction of the moving member 36 can allow ice M to be stably supplied to the holes 38 from the discharge opening 14. As the first inner wall surfaces 16a, 16a of the ice storage room 10 having an approximately rectangular shape as viewed planarly along the moving direction of the moving member 36 are formed perpendicularly, arching can be prevented though narrower the interval between the first inner wall surfaces 16a, 16a in the ice storage room 10 is.

### (Modifications)

The invention is not limited to the structure of the embodiment, and can be modified as follows.

(1) Although the total number of holes which are made to face the reception/delivery opening is adjusted by changing the amount of movement of the moving member which reciprocates linearly in the embodiment, it is possible to employ a structure which has a plurality of holes arranged apart from one another in the circumferential direction of a circular or fan-shaped moving member and adjust the total number of holes which are made to face the reception/delivery opening by controlling the angle of the rotating moving member.

(2) Although the structure according to the embodiment allows a user to set the amount of ice to be taken out, it is possible to employ a structure such that the input section automatically discriminates the size of a container placed at the take-out opening of the chute, and the amount of supply is set according to the size of the container.

(3) The hole may have a shape such that the opposite surfaces become spaced apart from each other in the downward direction, or a shape such that only one surface is spaced apart from the other surface in the downward direction, or all the surfaces may be set perpendicular.

(4) Although the amount of movement of the moving member is adjusted by indirect detection of the position of the moving member by the position detection means in the embodiment, the amount of movement may be adjusted by the drive time of the motor in the drive section or the number of rotations of the motor.

(5) The drive section is not limited to the combination of the motor and the screw shaft, and may take another structure, such as a hydropneumatic cylinder.

(6) It is desirable that the distance from the forward opening edge of the frontmost hole of the moving member in the moving direction to the rearward opening edge of the rearmost hole in the moving direction should be set equal to the front-rear dimension of the discharge opening or smaller than this dimension, so that all the holes are made to face the discharge opening at the measuring position. However, that hole in a plurality of holes which is positioned on the rear side in the moving direction can face under the discharge opening of the ice storage room during the movement of the moving member, thereby securing the time to take ice in, so that the hole positioned on the rear side in the moving direction at the measuring position may be positioned off the discharge opening. This brings about a merit such that the forward-rearward space needed in the moving direction can be made smaller.

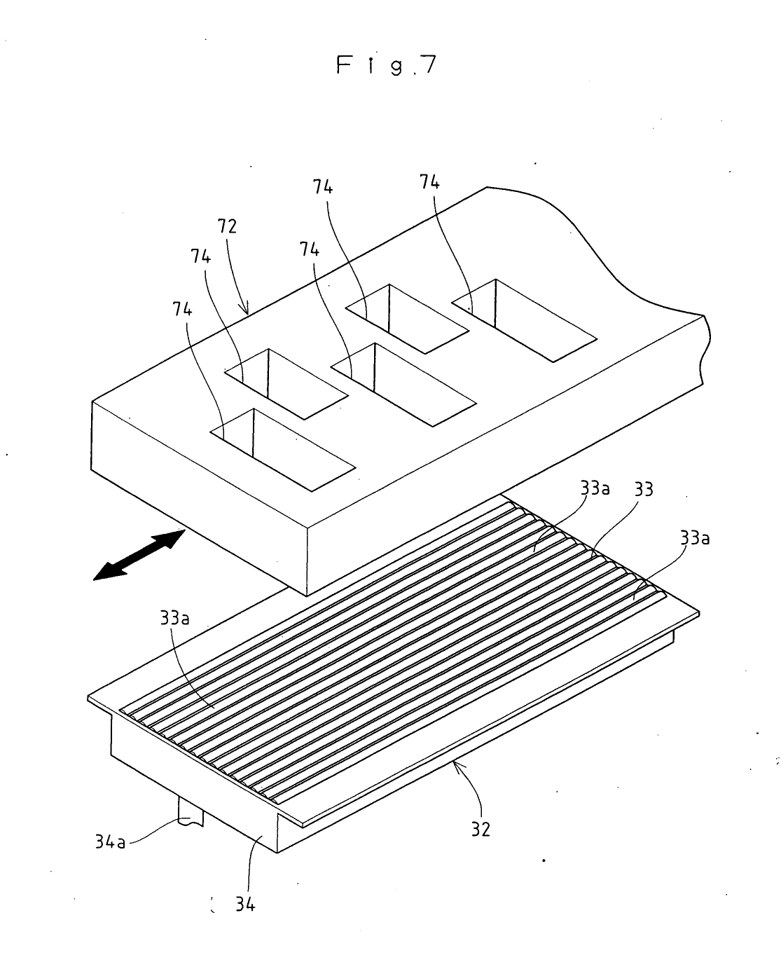

(7) FIG. 7 is a plan view showing a moving member 72 according to a modification. The moving member 72 according to the modification has a plurality of holes 74 arranged in a zigzag pattern alternately shifted in a direction (rightward/leftward direction) crossing the moving direction. This arrangement of the hole 74 can allow ice M to be filled unbiased in the holes 74 from the ice storage chamber 12 through the discharge opening 14, thus making it is possible to prevent occurrence of arching originating from the discharge of ice M only at a specific portion inside the ice storage room 10. In addition, as ice M can be filled in the holes 74 stably, the moving speed of the moving member 72 can be made faster, thus shortening the supply cycle of ice M. It is to be noted that the structure which has not been explained in the modification (6) is the same as that of the embodiment.

1. An ice dispenser comprising:
an ice storage room (10) having a discharge opening (14) for ice (M) provided at a bottom portion;
a chute (20), provided under the ice storage room (10), for guiding the ice M received at a reception/delivery opening (22) arranged away from a position directly under the discharge opening (14);
a fixed member (32) extending from under the discharge opening (14) to at least an edge portion of the reception/delivery opening (22);
a moving member (36, 72) provided between the discharge opening (14) and the fixed member (32) in such a way as to be movable along the fixed member (32), and having a plurality of vertically penetrating holes (38, 74) formed spaced apart in a moving direction;
a drive section (40) that moves the moving member (36, 72) to cause the individual holes (38, 74) to come under the discharge opening (14) and cause each hole (38, 74) to come over the reception/delivery opening (22);
an input section (50) that sets an amount of supply of the ice (M); and
a control section (52) that controls the drive section (40) according to the amount of supply of the ice (M) input from the input section (50) to change an amount of movement of the moving member (36, 72) from the discharge opening (14) side to the reception/delivery opening (22) side, thereby adjusting a total number of the holes (38, 74) sequentially facing the reception/delivery opening (22).

2. The ice dispenser according to claim 1, wherein the holes (38) formed so as to expand in an up-to-down direction.

3. The ice dispenser according to claim 1 or 2, wherein a pressing piece (60) elastically deformable in an upward/downward direction is formed over the reception/delivery opening (22), and movement of the moving member (36) places the pressing piece (60) into that hole (38) which faces the reception/delivery opening (22) from above.

4. The ice dispenser according to any one of claims 1 to 3, wherein inner wall surfaces (16a, 16a) of the ice storage room (10) along the moving direction of the moving member (36) is formed perpendicularly, and opposing inner wall surfaces (18a, 18a) of the ice storage room (10) which intersect the moving direction of the moving member (36) are formed obliquely so as to come closer to each other in an upward-to-downward direction.

5. The ice dispenser according to any one of claims 1 to 4, wherein an agitator (62) that guides the ice (M) toward the discharge opening (14) is provided inside the ice storage room (10).

6. The ice dispenser according to any one of claims 1 to 5, wherein a separator (33) having through holes (33a) smaller than the ice (M) provided therein constitutes a top surface of the fixed member (32), and a discharge pan (34) that receives ice-melted water falling down via the through holes (33a) is provided under the separator (33).

7. The ice dispenser according to any one of claims 1 to 6, wherein the plurality of holes (74) are arranged shifted in a direction intersecting the moving direction of the moving member (72).
